(19) United States
(12) Patent Application Publication
(10) Pub. No.: US 2011/0308951 A1
(43) Pub. Date: Dec. 22, 2011

(54) LONG-LASTING PRECAST ELECTROPHORESIS GEL

(75) Inventors: Yitzhak Ben-Asouli, Kfar Hanagid (IL); Farhat Osman, Sachnin (IL)

(73) Assignee: GENE BIO-APPLICATION LTD., Kfar Hanagid (IL)

(21) Appl. No.: 13/203,314

(22) PCT Filed: Feb. 25, 2010
(86) PCT No.: PCT/IL10/00163

§ 371 Date: Aug. 25, 2011

(30) Foreign Application Priority Data
Mar. 4, 2009 (IL) 197398

(51) Int. Cl. B01D 57/02; B32B 38/00

(52) U.S. Cl. 204/469; 156/246

(57) ABSTRACT

Disclosed is a precast polyacrylamide gel for use in gel electrophoresis, comprising polyacrylamide and an aqueous Tris 0.04 M to 0.15 M solution, at least one first ampholyte exhibiting an isoelectric point (pI) of from 5.4 to 6.4 at a total concentration of from 0.01 M to 0.4 M; and at least one second ampholyte exhibiting an isoelectric point (pI) of from 2.5 to 3.5 to adjust the pH to between 5.5 and 7.5 at the temperature of 25° C. The precast gels can be used for electrophoresis of oligopeptides, polypeptides, oligonucleotides, and polynucleotides under denaturating or nondenaturing conditions, and exhibit long shelf-life.

### FIELD OF THE INVENTION

The present invention relates to the field of gel electrophoresis. Specifically, the present invention relates to precast polyacrylamide gels, having a long-lasting shelf life, as well as a method for separation of proteins, peptides and nucleic acids.

### BACKGROUND OF THE INVENTION

Gel electrophoresis is a standard method to separate and identify biological molecules such as proteins, peptides, nucleic acids, oligonucleotides and other macromolecules based upon the mobility of the molecules in an electric field. Gels made of polyacrylamide (PAA) are commonly employed for electrophoresis due to convenient physical properties, including optical transparence, electrical neutrality and the ability to choose the desirable pore sizes.

Particularly, the SDS-polyacrylamide gel electrophoresis method is a powerful tool, which resolves proteins and peptides according to their molecular weights. To counter the variations in shape, charge and size of the proteins, the protein and peptides sample have to be initially denatured with SDS, an anionic detergent. The SDS anions bind to the proteins and peptides which consequently unfold and become uniformly coated with a negative charge, rendering the proteins and peptides similar in shape and charge-to-mass ratio. Moreover, SDS will not only unfold proteins and peptides, but it will also separate those with several subunits into individual polypeptide chains. The mixture of the denatured proteins and peptides is subsequently loaded into a well that has been cast in the top of a polyacrylamide gel. Under an electric field, the negatively charged polypeptides migrate through the gel towards the positive electrode at the bottom of the gel through a tangled network of polyacrylamide. Polypeptides which are smaller in size migrate more easily and faster through the network pores compared with the larger polypeptides. The distance traversed by the polypeptides in the gel relates only to their molecular weight as they all have a similar charge-to mass ratio.

The current practice is to prepare and run the gels using basic buffers under basic conditions, with a typical pH around 8.8. The Laemmli buffer system which uses Tris(hydroxymethyl)aminomethane and hydrochloric acid (Tris-HCl) is a typical choice for the preparation of polyacrylamide gels. The Laemmli gels are composed of two different gels (stacking and separating gels), each cast at a different pH. In addition, the gel electrode buffer (running buffer) is at a third, different pH. The separating gel is buffered with Tris by adjusting it to pH 8.8 with HCl. The stacking gel and the sample buffer are also buffered with Tris but adjusted to pH 6.8 with HCl. The running buffer is also buffered by Tris but its pH is adjusted to be slightly below the separating gel using glycine only.

The employment of gel and buffer discontinuities in the Laemmli system is designed to improve the resolution of electrophoresis (especially protein electrophoresis). The role of the chloride and glycine ions in this system is to establish a so called Kohlrausch boundary in the stacking gel in which the proteins are stacked into a thin layer between the leading chloride ions and the trailing glycine molecules.

The gels used for stacking and separation are produced from acrylamide with N,N′-methylene-bisacrylamide (BIS) as a cross-linker. A number of alternative acrylamide derivatives, such as N,N-dimethyl acrylamide, N-tris(hydroxymethyl)-methylacrylamide and N-hydroxyalkoxyalkylacrylamide have been suggested to be used instead of acrylamide and there also exist alternative divinyl compounds, such as N,N′-diallylditartardiamide or N,N′-diacryloylpiperazinem which can be used instead of BIS (U.S. Pat. No. 7,159,847).

Unfortunately the high pH values used in the separating gel in the Laemmli buffering system promote disulfide bond formation between cysteine residues in the proteins and peptides. Moreover, the high pH lowers the stability of the gels on storing. Currently, a major impediment in the production and sale of pre-cast polyacrylamide electrophoresis gel is the rather short shelf life of about three months. It is believed that the degradation of the gel is a consequence of hydrolysis of the amide groups to form partially anionic carboxylic acid derivatives under basic conditions. This hydrolysis leads to loss of resolution of the separated molecules, reduced migration distance of the separated molecules, and reduced intensity of protein staining.

Until recently, it has been thought that the degradation of the gels under basic conditions was inevitable. Attempts of extending the shelf life of gels by lowering the pH to circum neutral have been complicated by the parallel need for an effective yet inexpensive buffering system, as well as by the limitations regarding the concentration and pH of the buffers; lowering the gel pH to 7 or less may affect the ambit of molecular weights of the analyzed species, whereas Tris concentrations outside the range 0.05-0.2 M affect the electrophoresis pattern or the run time.

U.S. Pat. No. 6,783,651 discloses a buffer system for a long-lasting precast electrophoresis gel wherein separation occurs at neutral pH. The gel buffer solution in the buffer system contains a Bis-Tris titrated with hydrochloric acid to pH 7, while the running buffer solution contains MOPS or MES. Said electrophoresis gel system is described to have an increased useful shelf-life up to twelve months, but the buffer system requires special molecule markers. Moreover, the speed of electrophoretic migration is lower in the system when using prior electrophoresis buffer solutions, for example a commonly available Laemmli's running buffer solution containing glycine.

U.S. Pat. No. 6,733,647 describes a process for manufacturing gels with an extended shelf-life involving a gel buffer system comprising Tris at a concentration in the range of 0.15 to 0.25 M, titrated with HCl to a pH between 6.5-7.5, the running buffer solution containing HEPES. The polyacrylamide gel has somewhat higher shelf-life at 4° C., however, the pH of the gel increases to about 7.1-8.0 during storage at 4° C., causing a notable hydrolysis in the acrylamide and a number of proteins give broadened and/or diffused bands. Moreover, to obtain good protein separation results, this system uses a running buffer containing HEPES, an expensive material.

U.S. Pat. No. 5,464,516, EP 0 566 784 A1 and U.S. Pat. No. 6,726,821 disclose acrylamide gel for electrophoresis, comprising an aqueous solution of Tris (0.1 M), hydrochloric acid adjusting the pH to 7.4, and ampholytes with pI of 5.4 to 6.4 (e.g. glycine, serine and tricine) (0.144 M). However, the buffering capacity of Tris-HCl is reduced at neutral pH, therefore it does not allow sufficient movement of proteins. Moreover, the pH of the gel increases to about 8.0 during storage at 4° C., causing a notable hydrolysis in the acrylamide and a number of proteins give broadened and/or diffused bands. In addition, it is more safe to prepare gel stock solutions without HCl, since HCl is a very strong acid and requires fume-chamber, and other caution facilities.

In view of the above problems, and further in view of the supreme importance of the electrophoresis techniques for progress in molecular biology, there is continuing need for novel approaches. It is therefore an object of the invention to provide a precast polyacrylamide gel with a long shelf-life without compromising performance and used a commonly available Laemmli's running buffer solution containing tris-glycine.

Other objects and advantages of present invention will appear as description proceeds.

### SUMMARY OF THE INVENTION

The invention provides a precast polyacrylamide gel for use in gel electrophoresis, comprising polyacrylamide and i) an aqueous solution of tris(hydroxymethyl) aminomethane (Tris) at a concentration of 0.04 to 0.15 M; ii) at least one first ampholyte exhibiting an isoelectric point (pI) of from 5.4 to 6.4 at a total concentration of from 0.01 to 0.4 M; and iii) at least one second ampholyte exhibiting an isoelectric point (pI) of from 2.5 to 3.5 which titrates the pH of the gel buffer to a pH value lower than 7.5 at the temperature of 25° C.

A precast gel according to the invention preferably comprises an aqueous solution of Tris at a concentration of 0.04 to 0.15 M; at least one first ampholyte exhibiting an isoelectric point (pI) of from 5.4 to 6.4 at a total concentration of from 0.01 to 0.4 M; and at least one second ampholyte exhibiting an isoelectric point (pI) of from 2.5 to 3.5 to adjust the pH to between 5.5 and 7.0 at the temperature of 25° C.

In an embodiment of the invention, the precast gel comprises an aqueous solution of Tris at a concentration of 0.04 to 0.15 M; at least one first ampholyte exhibiting an isoelectric point (pI) of from 5.4 to 6.4 at a total concentration of from 0.01 to 0.4 M; and at least one second ampholyte exhibiting an isoelectric point (pI) of from 2.5 to 3.5 to adjust the pH to between 6.0 and 7.0 at the temperature of 25° C.

In another embodiment of the invention, the precast gel comprises an aqueous solution of Tris at a concentration of 0.04 to 0.15 M, at least one first ampholyte selected from the group consisting of glycine, serine, asparagine, tryptophane, methionine, and phenylalanine at a total concentration of from 0.01 to 0.4 M; and at least one second ampholyte selected from the group consisting of aspartic acid and glutamic acid to adjust the pH to between 6.2 and 6.8 at the temperature of 25° C.; and polyacrylamide at a concentration of from about 4 w/v % to about 20 w/v %.

In yet another embodiment of the invention, the gel comprises asparagine and glycine at a total concentration of from 0.1 to 0.3 M.

In another embodiment, the invention provides a precast polyacrylamide gel for use in gel electrophoresis, comprising asparagine and serine at a total concentration of from 0.1 to 0.3 M.

A gel according to the invention may comprise polyacrylamide at a concentration of from about 4 w/v % to about 20 w/v %.

In a specific embodiment, a gel according to the invention comprises Tris at a concentration of 0.05 to 0.1 M, at least one first ampholyte at a total concentration of from 0.1 to 0.3 M selected from asparagine, serine, glycine, tryptophane, methionine, and phenylalanine, and at least one second ampholyte selected from aspartic acid and glutamic acid to adjust the pH of from 6.2 to 6.8.

A gel according to the invention may be used in gel electrophoresis under denaturation conditions, for example in an SDS-PAGE system.

The gel of the invention may be used in gel electrophoresis under nondenaturation conditions.

A gel according to the invention may further comprise at least one component selected from surfactants, solvents, electrolytes, denaturation agents, and dyes.

In a specific components combination, the precast gel according to the invention comprises an aqueous solution of Tris at a concentration of 0.05 to 0.10 M; one or more first ampholytes exhibiting an isoelectric point (pI) of from 5.4 to 6.4 at a total concentration of from 0.15 to 0.35 M; polyacrylamide at a concentration of from about 4 w/v % to about 20 w/v %; one or more second ampholytes exhibiting an isoelectric point (pI) of from 2.5 to 3.5 to adjust the pH to between 6.2 and 6.8 at a temperature of 25° C.; and optionally one or more components selected from surfactants, solvents, electrolytes, denaturation agents, and dyes.

The invention, thus, provides a precast polyacrylamide gel for use in gel electrophoresis, while combining some known components and obtaining surprisingly good performance. Essentially, the improved gels comprise Tris; first ampholyte/s having pI of from 5.4 to 6.4 at a concentration in the range of 0.01 to 0.4 M, and second ampholyte/s exhibiting a pI of from 2.5 to 3.5 adjusting the pH of 5.5-7.5.

The invention provides electrophoretic gels with very high stability on storage, without compromising good separation of biomolecules when used in an electrophoretic system. Examples of said ampholyte include glycine, serine, asparagine, tryptophane, methionine, phenylalanine, aspartic acid and glutamic acid. A precast gel according to the invention has a shelf life of preferably more than three months, and most preferably more than 9 months. The gels are preferably stored from 4° C. to 25° C.

The invention is directed to a method of preparing a stable, high performance gel for electrophoresis of biomolecules, comprising i) providing an aqueous solution comprising acrylamide (AA) and bis-acrylamide, at a concentration of, for example, from 4 to 20 w/v %; Tris at a concentration of 0.04 to 0.15 M; one or more first ampholytes exhibiting an isoelectric point (pI) of from 5.4 to 6.4 at a total concentration of from 0.01 to 0.4 M; and one or more second ampholytes exhibiting an isoelectric point (pI) of from 2.5 to 3.5 to adjust the pH to between 5.5 and 7.5 at a temperature of 25° C.; ii) adding to the mixture obtained in step i) an aqueous solution of ammonium persulfate while mixing, and adding TEMED while mixing; iii) carefully homogenizing the mixture obtained in step ii) without trapping air bubbles; iv) casting the mixture obtained in step iii) into a slab-shape of desired dimensions; and v) sealing the slab-shaped gel in a polymeric wrap. A preferred method according to the invention comprises i) providing an aqueous solution comprising acrylamide and bis-acrylamide, Tris at a concentration of 0.05 to 0.15 M, at least one ampholyte selected from glycine, serine, asparagine, tryptophane, methionine, and phenylalanine at a concentration of from 0.1 to 0.35 M, and at least one ampholyte selected from aspartic acid and glutamic acid to a pH between 6.0 and 7.0; and polymerizing said acrylamide and bis-acrylamide, thereby obtaining a slab gel.

The invention aims at simplifying the laboratory operations associated with analyzing and separating biomolecules by means of electrophoresis, by providing gels with increased storage stability of precast gels without compromising good separation. The gels may be employed in known electrophoresis systems.

The invention will be described in more detail on hand of the appended figures.

### BRIEF DESCRIPTION OF THE FIGURES

FIG. 1A: Electrophoresis of proteins on a conventional polyacrylamide gel prepared with Laemmli's buffer system (for details see Example 1).

FIG. 1B: Electrophoresis of proteins on a polyacrylamide gel prepared with a buffer medium in accordance with the invention (for details see Example 1).

Lanes: 1, 2 BSA and lysosome proteins
3 molecular weight marker containing denatured proteins
4, 5, 6 E. coli extracts

### DETAILED DESCRIPTION OF THE INVENTION

It has now been found that a precast polyacrylamide (PAA) gel combining Tris with certain amino acids and slightly acidic pH, exhibits superior storage stability without compromising electrophoresis performance. Particularly useful is an aqueous composition exhibiting a pH around 6.5, comprising one or two first ampholytes having pI of around 6 at a total concentration of around 0.25 M, Tris at a concentration of around 0.07 M and one or two second ampholytes having pI of around 3 at a total concentration of around 0.05 M. It has been found that biomolecules are well separated on the gel, and that the good performance of the gel is preserved even when the gel is stored at 4° C. to 25° C. for prolonged periods, for example for one year.

The performance of a precast gel depends on its composition at the time of its preparation, and further on the storage time. Involved are interactions between the initial gel components, decomposition reactions in the gel during its storage, interactions between the components and the analyzed biomolecules, etc. The separation of the biomolecule in the course of an electrophoresis run is further affected by the electrophoresis conditions, such as the run time, the time courses of temperature and electric current, etc. In view of very many compounds being possibly combined in the gel, and so many parameters that may affect the performance, it is nearly impossible to predict an effect of even a minor change in the system. Since the gel electrophoresis has, for many years, been one of the most frequently used methods in biochemistry and biotechnology, any improvement is immensely important.

It has now been found that superior storage behavior is exhibited by gels of the invention that comprise ampholytes having a pI between 5.4 and 6.4, whereas the presence of further ampholytes having a pI between 2.5 and 3.5 instead of HCl is advantageous since the buffering capacity of Tris-HCl is reduced at neutral pH and it does not allow sufficient movement of proteins. Important is, in the gel of the invention, the presence of Tris, ampholytes having a pI between 5.4 and 6.4 and its titration by an acid ampholyte, particularly by aspartic acid and glutamic acid. In a preferred aqueous composition to be comprised in the gel of the invention, Tris should have a concentration of between 0.04 M and 0.15 M, said one or more first ampholytes at a total concentration of from 0.01 M to 0.4 M, and the ampholytic aspartic acid and glutamic acid adjust the pH to between 5.5 and 7.5 at a temperature of 25° C. Examples of said first ampholytes include amino acids having pI of from 5.4 to 6.4.

A precast gel according to the invention preferably comprises an aqueous solution of Tris at a concentration of from 0.04 M to 0.15 M, for example from 0.05 M to 0.10 M, for example 0.06 M. A precast gel according to the invention preferably comprises one or more first ampholytes exhibiting an isoelectric point (pI) of from 5.4 to 6.4 at a total concentration of from 0.01 M to 0.4 M, more preferably at a concentration from 0.1 M to 0.3 M, still more preferably form the range of 0.2 to 0.35 M. Examples of said first ampholyte include one or two ampholytes selected from glycine, serine, asparagine, tryptophane, methionine, and phenylalanine. One or more second ampholytes exhibiting an isoelectric point of from 2.5 to 3.5 are added to the gel composition to adjust the pH to between 5.5 and 7.5 at a temperature of 25° C., preferably between 5.5 and 7.0, still more preferably from about 6 to about 7, for example from 6.1 to 6.9 or from 6.2 to 6.8. Examples of said second ampholyte exhibiting an isoelectric point of from 2.5 to 3.5 include one or two ampholytes selected from aspartic acid and glutamic acid

Thus, an electrophoretic system is now enabled, comprising the gel which maintains its initial high quality identification and separation of biomolecules even after one year of storage or more. Said system comprises the gel and its stable medium in accordance with the invention, in which said biomolecules to be identified or separated move in the electric field, a commercial or other electrophoretic device providing said field, and necessary buffers in accordance with the required task, readily available or prepared by a person skilled in art [see, for example, Bollag, D. M. et. al. Protein Methods, Wiley-Liss, Inc. (1996)]. In said system, the pH of said medium is maintained at a suitable value, for example 6.3, during the storage at 4° C. to 25° C., and prevents hydrolysis of the polyacrylamide in the gel. The first ampholytes may be selected from amino acids, for example combinations of glycine, serine, asparagine, and phenylalanine.

An example of the composition for use in a precast polyacrylamide (PAA) gel according to the invention comprises a PAA or acrylamide:Bis (AA:Bis) in the range of 4-12% (w/v), about 50 mM Tris, about 200 mM glycine, and about 50 mM aspartic acid. Another example of a gel for separating biomolecules according to the invention is a PAA gel comprising 12% (w/v) AA:Bis, about 70 mM Tris, about 0.1 M asparagine, about 0.2 M glycine, and aspartic acid to pH 6.3 at 25° C., which gel is used for separating polypeptides in the molecular range of 10-250 kDa.

The invention is thus also directed to the method of separating biomolecules, comprising employing a PAA gel which preserves its superior separating features during prolonged storage, which gel contains beside Tris and first ampholyte/s exhibiting an isoelectric point (pI) of from 5.4 to 6.4, while the pH of the mixture is adjusted with second ampholytes exhibiting an isoelectric point (pI) of from 2.5 to 3.5 to a value between 6 and 7, for example to 6.1-6.8 or 6.2-6.6 or 6.3-6.5.

In an embodiment of the invention, it aims at providing a precast gel comprising PAA at a concentration of from about 4 w/v % to about 20 w/v % (w/v), for use in slab electrophoresis, the gel being sealed and stored for up to 12 months or more, and then used without loss in the initial resolution power. A preferred gel according to the invention may be stored for more than one year, for example up to 13 months, or up to 14 months, or up to 15 months. In one aspect of the invention, said gel is used for electrophoresis under denaturation conditions. Preferably said denaturation conditions comprise the use of SDS in SDS-PAGE. In another aspect of the invention, said gel is used in gel electrophoresis under nondenaturation conditions. Preferably, the gel is stored at a temperature lower than ambient, for example at about 4° C.

When mixtures of first ampholytes are used, they are designed to give an isoelectric point (pI) of from 5.4 to 6.4 at a total concentration of from 0.01 M to 0.4 M, as known to the person of skill in the art.

When a mixture of aspartic acid and glutamic acid at a total concentration of from 0.01 M to 0.15 M is used as the second ampholyte, it is designed to exhibit an isoelectric point (pI) of from 2.5 to 3.5 to adjust the pH to between 5.5 and 7.5 at the temperature of 25° C., as known to the person of skill in the art.

When using the term ampholyte in the instant specification, related to is a compound having in its molecule both basic and acidic groups.

These and other aspects of the invention will become clear from the following example, which is illustrative only and does not limit the invention. In the example below, results achieved with buffer system according to the present invention are compared with results achieved with conventional Laemmli's buffer system.

### EXAMPLE 1

For the experiment described below, small units for vertical slab gel electrophoresis were used. The equipment allowed two gels to be run in parallel. The gels were cast in mini gel cassettes (gel size 8 cm×6 cm×1.5 mm). A polyacrylamide gel was cast with an acrylamide concentration of 4% T/2.6% C in the stacking region and 12% T/2.6% C in the resolving region of the gel.

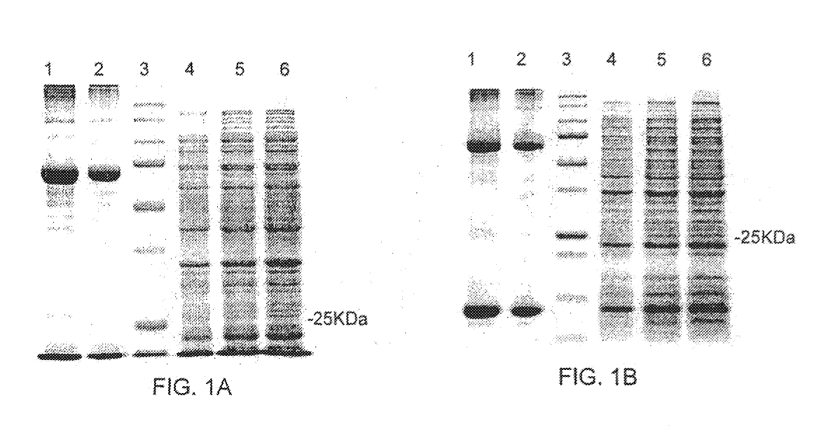

The solutions used in polymerization in FIG. 1A were prepared as Laemmli's buffer system, by mixing stock solutions of acrylamide/Bis, Tris and adding water to dilute to the appropriate concentration. The concentration of Tris in the gel composition was 0.25 M at the stacking region and 0.375 M at the resolving region. The pH of the stacking buffer and resolving buffer was adjusted to 6.8 and 8.8, respectively, by the addition of HCl before polymerizing. The gel was used after four months storage at 4° C.

The solutions used in polymerization in FIG. 1B were prepared by mixing stock solutions of acrylamide/Bis, Tris, glycine and adding water to dilute to the appropriate concentration. The concentration of Tris and glycine in the gel composition was 0.05 M and 0.2M, respectively. The pH of the composition before polymerizing was adjusted to 6.3 by addition of aspartic acid. The gel used after one-year storage at 4° C.

Samples of BSA and lysosome proteins were separated on these gels at lanes 1 and 2, samples of pre-stained molecular weight marker which was a commercially available marker containing proteins sample denatured by the addition of SDS were separated on these gels at lanes 3, samples of E. Coli extracts were separated on these gels at lanes 4, 5 and 6, by using an electrode buffer of Tris (25 mM), glycine (191 mM) and SDS (0.1%). The gels were electrophoresed for 60 minutes at a voltage of 200V. The proteins in the pre-stained molecular weight marker were 250 kDa, 150 kDa, 100 kDa, 75 kDa, 50 kDa, 37 kDa, 25 kDa, 20 kDa, 15 kDa and 10 kDa.

The proteins in the standard that remained on the gel in FIG. 1A were 250 kDa, 150 kDa, 100 kDa, 75 kDa, 50 kDa, 37 kDa, 25 kDa. The markers were distributed along the gel such that the protein of 75 kDa was about 30% of the way down the gel and the protein of 25 kDa was about 80% of the way down the gel. During the gel storage at 4° C. for four month, while pH of the gel was 8.8 (FIG. 1A), a notable polyacrylamide hydrolysis was observed. The proteins in the standard that remained on the gel in FIG. 1B were 250 kDa, 150 kDa, 100 kDa, 75 kDa, 50 kDa, 37 kDa, 25 kDa, 20 kDa, 15 kDa and 10 kDa. The markers were distributed along the gel such that the protein of 75 kDa was about 18% of the way down the gel and the protein of 25 kDa was about 57% of the way down the gel. Remarkably, the rate of hydrolysis of this gel (FIG. 1B) gel was significantly lower compared with the gel with pH 8.8 (FIG. 1A), although it was stored for a much longer period of time (one year storage at 4° C.). Thus, the gel prepared in accordance with the invention could be stored for over a year without any change or deterioration in the gel shape and performance.

While this invention has been described in terms of some specific examples, many modifications and variations are possible. It is therefore understood that within the scope of the appended claims, the invention may be realized otherwise than as specifically described.

1. A precast polyacrylamide gel for use in gel electrophoresis, comprising polyacrylamide and:
i) an aqueous solution of tris(hydroxymethyl)aminomethane (Tris) at a concentration of from 0.04 M to 0.15 M;
ii) at least one first ampholyte exhibiting an isoelectric point (pI) of from 5.4 to 6.4 at a total concentration of from 0.01 M to 0.4 M; and
iii) at least one second ampholyte exhibiting an isoelectric point (pI) of from 2.5 to 3.5 to adjust the pH to between 5.5 and 7.5 at the temperature of 25° C.

2. A precast gel according to claim 1, comprising:
i) an aqueous solution of Tris at a concentration of from 0.4 M to 0.15 M;
ii) at least one first ampholyte exhibiting an isoelectric point (pI) of from 5.4 to 6.4 at a total concentration of from 0.01 M to 0.4 M; and
iii) at least one second ampholyte exhibiting an isoelectric point (pI) of from 2.5 to 3.5 to adjust the pH to between 6.0 and 7.0 at the temperature of 25° C.

3. A precast gel according to claim 1, comprising:
i) Tris at a concentration of 0.06 M to 0.10 M;
ii) at least one first ampholyte selected from the group consisting of glycine, serine, asparagine, tryptophane, methionine, and phenylalanine at a total concentration of from 0.1 M to 0.35 M;
iii) at least one second ampholyte selected from the group consisting of aspartic acid and glutamic acid to adjust the pH to between 6.2 and 6.8 at the temperature of 25° C.; and
iv) polyacrylamide at a concentration of from about 4 w/v % to about 20 w/v %.

4. A gel according to claim 1, wherein said first ampholyte comprises asparagine and glycine at a total concentration of from 0.2 M to 0.35 M.

5. A gel according to claim 1, wherein said first ampholyte comprises asparagine and serine at a total concentration of from 0.2 M to 0.35 M.

6. A gel according to claim 1, comprising polyacrylamide at a concentration of from about 4 w/v % to about 20 w/v %.

7. A gel according to claim 1, comprising Tris at a concentration of 0.06 to 0.1 M, at least one first ampholyte selected from asparagine, serine, glycine, tryptophane, methionine, and phenylalanine at a total concentration of from 0.15 to 0.35 M, and at least one second ampholyte selected from aspartic acid and glutamic acid to adjust the pH of from 6.2 to 6.8.

8. A precast gel according to claim 1, comprising
i) polyacrylamide at a concentration of from about 4 w/v % to about 20 w/v %;
ii) an aqueous solution of tris(hydroxymethyl)aminomethane (Tris) at a concentration of 0.06 to 0.10 M;
iii) at least one first ampholyte exhibiting an isoelectric point (pI) of from 5.4 to 6.4 at a total concentration of from 0.15 to 0.35 M; and
iv) at least one second ampholyte exhibiting an isoelectric point (pI) of from 2.5 to 3.5 to adjust the pH to between 6.2 and 6.8 at the temperature of 25° C.

9. A gel according to claim 1 for use in gel electrophoresis under denaturation conditions.

10. A gel according to claim 1, for use in SDS-PAGE.

11. A gel according to claim 1 for use in gel electrophoresis under nondenaturation conditions.

12. A gel according to claim 1, further optionally comprising at least one component selected from surfactants, solvents, electrolytes, denaturation agents, and dyes.

13. A precast gel according to claim 1, comprising
i) polyacrylamide at a concentration of from about 4 w/v % to about 20 w/v %;
ii) an aqueous solution of tris(hydroxymethyl)aminomethane (Tris) at a concentration of 0.06 to 0.10 M;
iii) at least one first ampholyte exhibiting an isoelectric point (pI) of from 5.4 to 6.4 at a total concentration of from 0.15 to 0.35 M;
iv) at least one second ampholyte exhibiting an isoelectric point (pI) of from 2.5 to 3.5 to adjust the pH to between 6.2 and 6.8 at the temperature of 25° C.; and
v) one or more components selected from surfactants, solvents, electrolytes, denaturation agents, and dyes.

14. A precast gel according to claim 1, having a shelf life of at least 12 months.

15. A method of preparing a stable, high performance gel for electrophoresis of biomolecules, comprising
i) providing an aqueous solution comprising from acrylamide (AA) and bis-acrylamide; from 0.05 to 0.15 M Tris; at least one ampholyte exhibiting an isoelectric point (pI) of from 5.4 to 6.4 at a total concentration of from 0.01 to 0.4 M; and at least one ampholyte exhibiting an isoelectric point (pI) of from 2.5 to 3.5 to adjust the pH between 5.5 and 7.5 at the temperature of 25° C.;
ii) adding into the mixture obtained in step i) an aqueous solution of ammonium persulfate while mixing, and adding tetramethylethylenediamine (TEMED) while mixing;
iii) carefully homogenizing the mixture obtained in step ii) without trapping air bubbles;
iv) casting the mixture obtained in step iii) into a slab-shape of desired dimensions; and
v) sealing the slab-shaped gel in a polymeric wrap.

16. A method according to claim 15, wherein the concentration of the acrylamide (AA) and bis-acrylamide is from 4 to 20 w/v %.

17. A method according to claim 15, comprising i) providing aqueous solution comprising AA:Bis, Tris at a concentration of 0.05 to 0.15 M, at least one first ampholyte selected from glycine, serine, asparagine, tryptophane, methionine, and phenylalanine at a concentration of from 0.15 to 0.35 M, and at least one second ampholyte selected from aspartic acid and glutamic acid to a pH between 6.0 and 7.0; and ii) polymerizing said PAA, thereby obtaining a slab gel.

18. A method according to claim 15, wherein said biomolecule is selected from oligopeptides, polypeptides, oligonucleotides, and polynucleotides.

19. A method according to claim 15, wherein said biomolecule is selected from proteins and nucleic acids.
